(19) United States
(12) Patent Application Publication
(10) Pub. No.: US 2023/0296317 A1
(43) Pub. Date: Sep. 21, 2023

(54) DRYER FOR DRYING A PANEL-SHAPED PRODUCT

(71) Applicant: GRENZEBACH BSH GmbH, Bad Hersfeld (DE)

(72) Inventor: Christoph STRAETMANS, Schenklengsfeld (DE)

(73) Assignee: GRENZEBACH BSH GmbH, Bad Hersfeld (DE)

(21) Appl. No.: 18/017,219

(22) PCT Filed: Jul. 23, 2021
(86) PCT No.: PCT/EP2021/025278

§ 371 Date: Jan. 20, 2023

(30) Foreign Application Priority Data
Jul. 23, 2020 (DE) 10 2020 004 454.9

(51) Int. Cl. F26B 21/02; F26B 15/12; F26B 21/00

(52) U.S. Cl. CPC F26B 21/028; F26B 15/12; F26B 21/004

(57) ABSTRACT

A dryer for drying a strip or panel-shaped product, in particular gypsum board or veneer panels, having a plurality of tiers, having an outer and an inner housing and an inner housing separated from the outer housing by a first and second partition wall, having conveying devices for conveying the product, upper and lower nozzle boxes arranged transversely to the conveying direction and extend over the width of the conveying devices between the dividing walls, have in each case one inflow opening on one end assigned to the first separating wall and are closed on the other end assigned to the second partition wall. Nozzle openings for blowing out drying air are present at least on one side of the product passing through. The dryer includes at least on the first partition wall adjustable adjusting plates wherein the inflow openings of the upper and lower nozzle boxes can be adjusted.

The invention relates to a dryer for drying a strip or panel-shaped product, in particular gypsum board or veneer panels, having a plurality of tiers, having an outer housing and an inner housing which is separated from the outer housing by a first and a second partition wall, having conveying devices for conveying the product and having upper and lower nozzle boxes which are arranged transversely to the conveying direction and which extend over the width of the conveying devices between the partition walls, have an inflow opening at an end assigned to the first partition wall and are closed at the other end assigned to the second partition wall, and having nozzle openings for blowing out drying air at least on one side of the product passing through according to the preamble of claim 1.

Such a dryer is known from DE 197 01 426 A1. There, the problem is taken of achieving uniform drying of the product to be dried, that is to say in particular of the gypsum or veneer panels, over the entire width of the conveying device. It is assumed here that the nozzle boxes are wedge-shaped, so that the cross-section decreases from the inflow side towards the other end. As a result, a constant pressure should be maintained within the nozzle box over the entire length. The wedge-shaped nozzle boxes are arranged in such a way that the distance of the boundary wall facing the continuous plate increases from the inflow side in the direction of the outflow side. As a result, an increasing amount of larger cross-section is made available to the outflowing air with increasing distance from the inflow side. In order to obtain a uniform speed of the drying air jets impacting the plate despite the uneven spacing between the nozzle box and the continuous plate over the entire width, the nozzles are designed as short pipe pieces, the length of which is greater, the greater the length of which is arranged at a distance from the inflow side. As a result, the distance between the nozzle mouth and the continuous plate is kept constant over the entire width.

Non-uniform drying is observed to a particularly great extent in dryers which have a plurality of conveyor devices arranged one above the other in a stack-like manner and for this reason have a very compact structure. The cross-sectional dimensions of the individual nozzle boxes are very small in relation to the length. Viewed in the longitudinal direction of the nozzle box, an uneven distribution of the speed can result, with which the air jets flow out of the nozzle openings. As a result of the air flowing out in the transverse direction, the nozzle jets are increasingly deflected from the vertical with increasing distance from the inflow side. The air flowing out between the nozzle boxes effects an increasing cooling of the nozzle boxes in the direction of the outflow side, which leads to a cooling of the drying air and the last end to a deterioration of the drying effect.

In DE 197 01 426 A1, it is already taken into account that the heat transfer from an impacting air stream to a plate to be dried is a function of the distance between the nozzle mouth and the plate. For this reason, the nozzle boxes are displaceable at one end in the vertical direction and fixed in an inclined position, in which the distance of the nozzle openings from the transport plane of the product to be dried on one side of the dryer is greater than on the other side.

Another problem of drying a panel-shaped product is that the drying effect of the hot air from level to level decreases upwards or has proven to be non-uniform overall.

The aim of the invention is to provide a measure by means of which a uniform drying effect is achieved over the totality of the nozzle boxes.

According to the invention, this object is achieved, as indicated in claim 1.

Adjustable blend or adjusting plates are provided on the first partition wall, ie, where the inflow openings of the nozzle boxes are arranged, by means of which the openings of the nozzle boxes can be adjusted.

This means that floors with nozzle boxes which are supplied with drying circulating air inside the dryer are partially closed by the adjusting plates on the opening side, so that the opening area available for the inflow of the air is reduced. The sheets can be individually adjusted at each individual opening, so that a more uniform drying is achieved over all levels of the dryer. The sheets can be adjusted in each case if the desired uniform drying result has not yet been reached.

Advantageous developments result from the dependent claims and the description, in particular in conjunction with the drawings.

It is advantageous, in particular, if the blend sheets can be adjusted jointly in stages. This can be achieved if the blend sheets belonging to one tier are connected to one another by rods or struts.

It has also been found to be advantageous if the openings to the upper and lower nozzle boxes can each be adjusted jointly by the adjusting plates in each case.

According to a further advantageous embodiment, it is provided that the cross-sections of the inflow openings of the nozzle boxes can be changed from above by the adjustment of the adjusting plates.

In addition, it can be advantageously provided that the blend sheets can be fixed, in particular latchable, at predetermined positions. Once adjusted positions can then be easily restored even after a cleaning process in which they were removed.

According to a further advantageous embodiment, it is provided that the adjusting plates can be adjusted electrically, in particular with step or piezo motors. Motorized adjusting means allow simple adjustability of the adjusting plates without the need for operating personnel to manually adjust them. The blend sheets can be adjusted at any time. In the fully open state, the adjusting plates do not impede the cleaning of the nozzle plates, for example with compressed air or water.

In order to facilitate the adjustability of the adjusting plates, openings or doors are provided in the outer housing, of which openings or doors can be mechanically adjusted from said openings.

In order to be able to adjust the blend sheets even when dust between the inner wall of the dryer, on which the blend sheets are mounted, impedes the movement of the blend sheets, gears are advantageously provided, by means of which either individual blend sheets or a plurality of blend sheets can be jointly adjusted in each case. By means of a transmission gear, the expenditure of force can be reduced in order to adjust the blend sheets.

A particularly good effect of the glare plates is achieved if sensors for measuring the temperature, the moisture and/or drying effect of the drying air are present and the glare plates, in particular by means of the motors, are adjustable in such a way that the drying effect is evened out on all levels. The sensors are preferably part of a control system or a control system for adjusting the blend sheets as a function of temperature and/or humidity, etc.

As a result of the use of the blend sheets according to the invention, the air flow in the nozzle boxes can be increased by up to 20% by lifting the blend sheets and lowered by up to 20% by lowering the blend sheets.

Likewise, the adjustability or in particular a different adjustment compensates for flow differences of the air flows between the upper and the lower nozzle boxes. Since the lower nozzle boxes have a stronger air flow, the latter must be throttled more strongly in them than in the upper nozzle boxes.

The invention is explained in more detail below in an exemplary embodiment with reference to the drawings, in which:

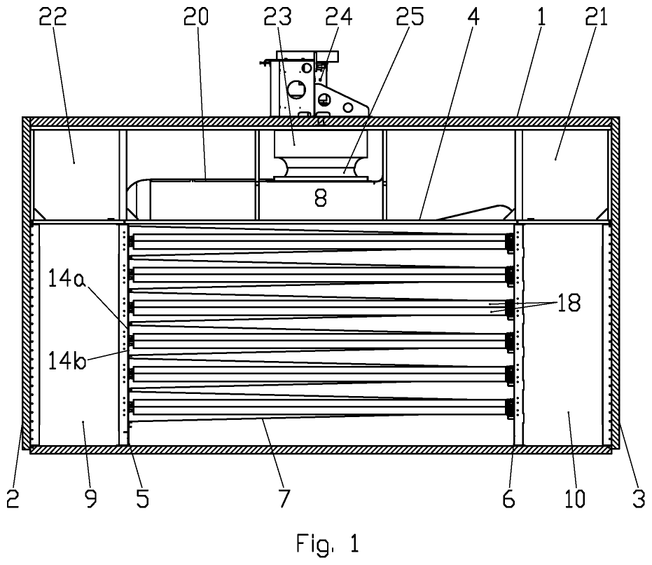

FIG. 1 shows a cross-section of a dryer according to the prior art equipped with partitions and in the region between the partition walls with nozzle boxes,

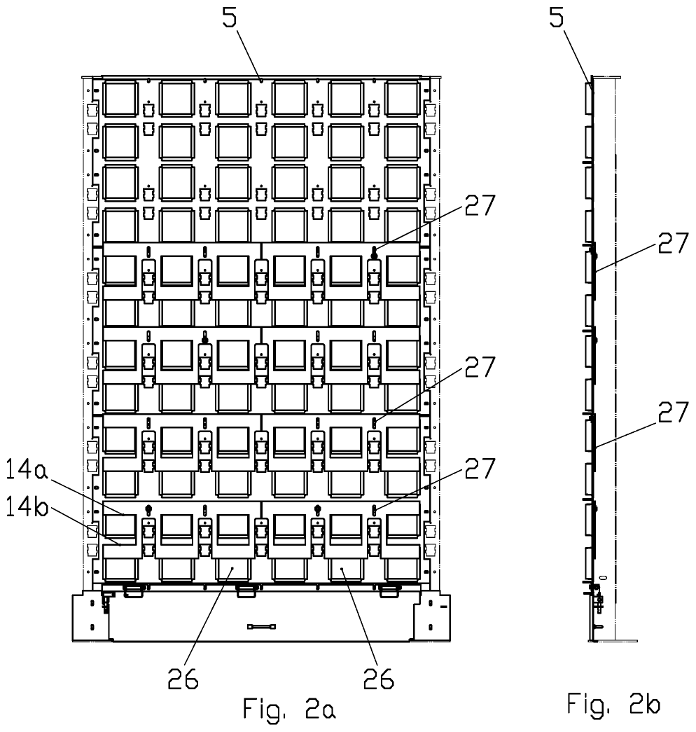

FIG. 2a shows a plan view of the opening-side partition of a dryer according to the invention with openings of nozzle boxes, which are partially covered by adjusting plates, slightly enlarged compared to the illustration in FIG. 1,

FIG. 2b shows the separating wall equipped with the adjusting plates according to FIG. 2a in cross-section,

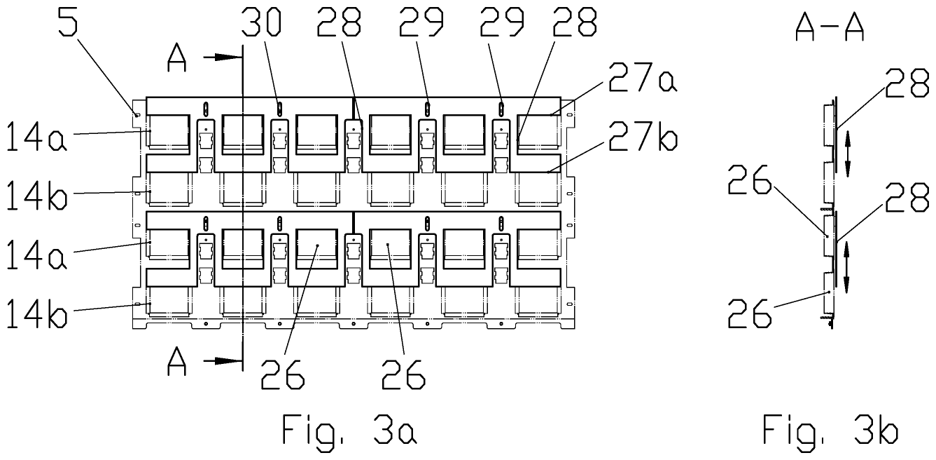

FIG. 3a shows a further plan view of an arrangement of adjusting plates mounted on a partition for upper and lower nozzle boxes, which are jointly adjustable, and

FIG. 3b shows the separating wall according to FIG. 3a equipped with the adjusting plates according to FIG. 3a in cross-section.

A known dryer (FIG. 1) consists, for example, of thirty or more parts lined up next to one another in a modular manner. A compartment measures 2.0 m to 2.5 m in the conveying direction and is 5.0 m to 6.0 m wide. It has a ceiling 1 and outer side walls 2, 3 which form the outer housing.

In the compartment, a core region 7 is separated from a circulating air channel by an intermediate ceiling 4, a partition wall 5 and a partition wall 6 equipped with outlet openings, which can also be designed as a lattice frame. The latter consists of a horizontal channel 8 above the core region 7, a lateral vertical distributor channel 9 and a collecting channel 10 arranged substantially mirror-symmetrically on the opposite side. In the core region 7, rollers 11 are arranged in a plurality of planes, for example approximately eight to twelve planes, which lie one above the other at equal distances of approximately 250 to 350 mm, which rollers 11 are mounted on the separating walls 5, 6. The rollers 11 can be driven at the same speed by chains (not shown); they therefore form a roller conveyor in each tier which extends over the entire length of the dryer.

Below and above the transport planes in which the plates lying on the individual roller conveyors move continuously through the dryer, nozzle boxes 14 a, 14 b, which extend over the width of the roller conveyor, are arranged in the interspaces of adjacent rollers 11. The boundary wall of the nozzle boxes 14a, 14b facing the transport plane is provided with nozzle openings (likewise not shown here) for inflating drying air onto continuous plates of the product to be dried, for example the gypsum or veneer panels. One end of the nozzle boxes 14a, 14b is designed as an inflow opening in the partition wall 5, and the other end 18 is closed. The nozzle boxes 14 a, 14 b are wedge-shaped so that their cross-section continuously decreases in the direction of the closed end 18. Between adjacent transport planes, an upper nozzle box 14 a is mechanically connected to an immediately underlying nozzle box 14 b in the region of the openings, so that they form a double box and have, for example, a common inflow opening. Alternatively, the nozzle boxes 14a, 14b have separate openings. The end, at which the inflow opening is located, fits snugly in a rectangular recess in the partition wall 5. It is fastened immovably to the partition wall 5 and is sealed all around by a collar.

The horizontal channel 8 is divided into a suction chamber 21 and a pressure chamber 22 by means of a partition plate 20 which is shaped like a staircase. The suction chamber 21 is in open connection with the collecting channel 8, the pressure chamber 22 with the distributor channel 9. Centrally in the horizontal channel 8, specifically in the pressure chamber 22 separated by the separating plate 20, a free-running, housing-free radial impeller 23 is accommodated, whose drive shaft penetrates the ceiling 1 and is coupled to a drive 24 seated on the ceiling 1. An opening in a horizontal region of the separating plate 20 corresponds to the suction funnel 25 of the radial impeller 23, so that the radial impeller 23 is connected on the suction side to the suction chamber 21.

In a similar embodiment, as shown in FIG. 1 on the basis of the prior art, inflow openings 26 of the nozzle boxes 14a, 14b are provided in the partition wall 6 (FIGS. 2a, 2b) according to the invention. By means of adjusting plates 27 which can be lowered in each case from above, the openings 26 are partially closed in order to reduce the inflow of the warm drying air, in particular in the lower levels of the nozzle boxes 14a, 14b.

The adjusting plates 27 are jointly adjusted in each case. For this purpose, they are connected to one another by a frame.

In a further embodiment (FIGS. 3a and 3b), the openings 26 of the upper and lower nozzle boxes 14a, 14b are partially covered from above in each tier of the dryer by interconnected adjusting plates 27a and 27b. The adjusting plates 27a, 27b are connected to one another by webs 28. Its adjustment range is determined by elongated holes 29 between the upper adjusting plates 27a. Mandrels 30 attached to the partition wall 5 project into the elongated holes 29.

1. A dryer for drying a strip-like or plate-like material having a plurality of tiers, having an outer housing and an inner housing separated from the outer housing, with conveying means for conveying the material and with upper and lower nozzle boxes arranged transversely to the conveying direction, which extend over the width of the conveying means between the partition walls, wherein the nozzle boxes each having an inflow opening at one end associated with the first partition wall and being closed at the other end associated with the second partition wall, and the nozzle boxes being provided with nozzle openings for blowing drying air at least onto one side of the material passing through, wherein adjustable baffle plates are provided at least on the first partition wall, by means of which the inflow openings of the upper and lower nozzle boxes can be adjusted.

2. The dryer according to claim 1, wherein the adjusting plates are adjustable in stages.

3. The dryer according to claim 1, wherein the openings to the respective upper and lower nozzle boxes are adjustable jointly by the adjusting plates per level.

4. The dryer according to claim 1, wherein the cross-sections of the inflow openings of the nozzle boxes are fixable from above by the adjustment of the adjusting plates.

5. The dryer according to claim 1, wherein the adjusting plates are fixable at predetermined positions.

6. The dryer according to claim 1, wherein the adjusting plates are adjustable electrically.

7. The dryer according to claim 1, wherein openings or doors are provided in the outer housing, by means of which the adjusting plates are adjustable mechanically.

8. The dryer according to claim 1, wherein the adjusting plates are adjustable by means of a transmission.

9. The dryer according to claim 1, wherein sensors for measuring the drying effect of the drying air are present and that the adjusting plates are adjustable in such a way that the drying effect is evened out on all levels.

10. The dryer according to claim 1, wherein the air flow in the nozzle boxes is increased by up to 20% by lifting the adjusting plates and is lowered by up to 20% by lowering the blend sheets.

11. The dryer according to claim 1, wherein in order to compensate for flow differences, the air flow in the respective lower nozzle boxes is stronger than in the upper nozzle boxes.
